(19) United States
(12) Patent Application Publication
(10) Pub. No.: US 2026/0312092 A1
(43) Pub. Date: Oct. 8, 2026

(54) CONDITIONING METHOD AND CONDITIONING DEVICE

(71) Applicant: Robert Bosch GmbH, Stuttgart (DE)

(72) Inventors: Thomas Mittermeier, München (DE); Ulrich Berner, Stuttgart (DE)

(21) Appl. No.: 19/482,295

(22) PCT Filed: May 7, 2024
(86) PCT No.: PCT/EP2024/062502

§ 371 Date: Nov. 7, 2025

(30) Foreign Application Priority Data
May 10, 2023 (DE) 10 2023 204 309.2

(51) Int. Cl. H01M 8/04302; H01M 8/0438; H01M 8/04537; H01M 8/04701; H01M 8/04746; H01M 8/04828; H01M 8/04858

(52) U.S. Cl. CPC H01M 8/04302; H01M 8/04395; H01M 8/04552; H01M 8/04708; H01M 8/04753; H01M 8/04835; H01M 8/04873; H01M 8/04902

(57) ABSTRACT

The invention relates to a method (100) for conditioning (160) at least one fuel cell (10) to a maximum current target value (I_target) for operating the fuel cell (10), in particular of a fuel cell stack (12), in a conditioning device (14), comprising the steps of:
applying (110) a load voltage (U_load) to the fuel cell (10) by means of a voltage source (16) such that a load current (I_load) is continuously drawn (120),
specifying (130) the maximum current target value (I_target) in a control unit (18),
supplying (140) a substoichiometric gas to a cathode side (20) of the fuel cell (10) by means of a gas source (22), and supplying (140) hydrogen to an anode side (24) of the fuel cell (10) by means of a hydrogen source (26) for a specified duration (T) T, wherein, during the duration (T) T, the drawn (120) load current (I_load) corresponds to the maximum current target value (I_target), and wherein the gas source (22) and the hydrogen source (26) are controlled and/or regulated (150) over the duration (T) T by means of the control unit (18), whereby the fuel cell (10) is conditioned (160) to the maximum current target value (I_target).

The invention additionally relates to a conditioning device.

### BACKGROUND

The invention relates to a method for conditioning as well as a conditioning device with the features of the disclosure.

A proton exchange membrane (PEM) fuel cell consists, at its core, of a proton-conducting membrane printed on both sides with an electrode consisting of an ionomer and platinum nanoparticles on a carbon carrier. This compound is also known as a catalyst coated membrane (CCM).

Each CCM must undergo so-called conditioning to achieve maximum power generation performance during operation. For conditioning such a catalyst coated membrane, there are various processes in which, among other things, electrical load, potential, humidity and temperature are varied or also constantly adjusted in a chronological sequence. In an industrial environment, it is typical to perform conditioning after stacking many (up to several hundred) catalyst coated membranes (CCMs) in conjunction with gas diffusion layers and bipolar plates, as well as current collectors, insulators and end plates in the finished fuel cell stack.

Current methods of conditioning a fuel cell stack have a duration in the range of hours, and can thus become a limiting step in the manufacturing chain for producing a high-performance fuel cell stack.

### SUMMARY

Therefore, the invention proposes a method as well as a conditioning device In this context, features and details described in connection with the method according to the invention clearly also apply in connection with the conditioning device according to the invention, and vice versa, so that mutual reference to the individual considerations of the invention always is or can be made with respect to the disclosure.

A first aspect of the invention is a method for conditioning at least one fuel cell to a maximum current target value for operating the fuel cell, in particular a fuel cell stack, in a conditioning device comprising the steps of:
applying a load voltage to the fuel cell by means of a voltage source, such that a load current is continuously drawn,
specifying the maximum current target value in a control unit,
supplying a substoichiometric gas to a cathode side of the fuel cell by means of a gas source, and supplying hydrogen to an anode side of the fuel cell by means of a hydrogen source for a specified duration T, wherein, during the duration T, the drawn load current corresponds to the maximum current target value, and wherein the gas source and the hydrogen source are controlled and/or regulated over the duration T by means of the control unit, whereby the fuel cell is conditioned to the maximum current target value.

It has been shown that conditioning of the fuel cell by means of a (temporary) substoichiometric gas at the load holding points with a conventional electronic single quadrature load can lead to significantly accelerated conditioning. A cell voltage close to 0 V can be established in the fuel cell and current and, in particular, water/heat are produced constantly.

Alternatively, the procedures presented may also be utilized as a recovery procedure for recovering reversible loss mechanisms.

The method may thus increase the service life and power of a fuel cell prior to commissioning and contribute to an extension of the service life after a longer period of operation. This process, therefore, also increases the sustainability of a fuel cell.

In the method, it is conceivable that the load current is sensed by a current sensor of a sensing unit of the control unit to determine the drawn load current for controlling and/or regulating the gas source and/or the hydrogen source.

The sensed drawn load current can then be compared in a comparison unit of the control unit to the specified maximum current target value.

In the present case, a substoichiometric gas is understood to be a gas whose oxygen content is too low to fully convert the amount of fuel. The stoichiometric ratio with respect to oxygen is less than 1. This may be achieved by actively supplying nitrogen to the supplied gas, for example air, to reduce the oxygen ratio to the substoichiometric range.

Care is taken to ensure that the composition of the gas in the substoichiometric range does not result in liquid accumulation in the channels of the fuel cell. However, the production of a higher quantity of liquid, for example water, is completely desired, as this improves the success of reducing the platinum surface area while simultaneously washing away impurities and the reduced substances.

In the context of the invention, it may be advantageous that a pressure drop is sensed in the cathode side of the fuel cell by means of at least one pressure sensor of a sensing unit and/or that a cell voltage is sensed in the fuel cell by means of at least one voltage sensor of the sensing unit, wherein the gas source and/or the voltage source are controlled and/or regulated by the control unit as a function of the sensed pressure drop in the cathode side and/or the sensed cell voltage in the fuel cell, such that the voltage source provides at least one load pulse to increase the cell voltage in the fuel cell and/or the gas source provides at least one gas pulse to increase the pressure drop in the cathode side by means of the control unit.

By pulsing the load or the gas, the voltage and/or the pressure drop in the fuel cell are advantageously increased, and this leads to the liquid resulting from the reaction of the hydrogen and the gas in the fuel cell being forced away from the channels or discharged.

By pulsing the load or the gas or its mass flow, it is possible to change the stoichiometry of the gas supplied and to reduce the oxygen content, and this can reduce the duration of the conditioning method.

In the context of the invention, it is conceivable that the gas pulse of the gas source and/or the load pulse of the voltage source is provided cyclically and/or overlapped and/or sequentially by means of the control unit.

The gas quantity or load level per pulse may vary. Alternatively or additionally, the gas pulse and/or the load pulse can be provided cyclically, in which case the repetition of different gas quantities or load levels can be cyclical. As a result, different pressure losses or cell voltages are produced whereby the amount of liquid changes simultaneously so that the reduction can be improved and the cleaning and/or washing out of contaminants from the fuel cell can be carried out optimally.

A variation of the load may result in the potential being increased in areas so that oxidation is improved.

In the context of the invention, it is contemplated that the pressure drop in the cathode side is increased by 10 mbar to 500 mbar, preferably 25 mbar to 100 mbar, more preferably 30 mbar to 60 mbar, by means of the gas pulse in the cathode side and/or the load pulse in the fuel cell.

An increased pressure drop can ensure that the channels are free of liquid in order to be able to further perform the reduction optimally.

It is further contemplated that the gas pulse and/or the load pulse will be provided for a pulse duration of 0.01s to 200s, preferably 0.5s to 100s, further preferably 1s to 20s.

As a result, the resulting amount of liquid can be controlled and/or regulated in a simple manner. As a result, discharging of the liquid from the channels and washing out the oxidation contaminant from the fuel cell can be improved.

It is also contemplated that a substoichiometric gas is supplied to the cathode side with a temperature of 20° C. to 100° C., preferably from 30° C. to 80° C., further preferably from 40° C. to 70° C.

By means of the temperature, the density of the gas can be influenced, whereby the mass flow of the gas can be adjusted. At the same time, the speed of reduction on the platinum surface may be adjusted via temperature.

In the context of the invention, it is optionally possible for a substoichiometric gas to be supplied to the cathode side at an absolute pressure of from 1 bar to 4 bar, preferably from 1.1 bar to 3 bar, further preferably from 1.5 bar to 2.5 bar.

The pressure can ensure the pressure drop to reduce the platinum surface. At the same time, a sufficient pressure drop is provided to discharge the liquid from the channels of the cathode of the fuel cell.

Furthermore, it may be contemplated in the context of the invention that a substoichiometric gas is supplied to the cathode side at a relative humidity of 50% to 200%, preferably 90% to 150%, further preferably 90% to 130%. A relative humidity above 100% means that liquid water condenses at the cell inlet.

The reaction time and, in particular, the time until the desired and required amount of liquid forms can be influenced via the relative humidity of the gas. This may result in a quick reduction of the platinum surface.

With respect to the present invention, it is conceivable that a stoichiometric gas is supplied to the cathode side with a stoichiometry relative to oxygen of less than 1, preferably less than 0.95, further preferably less than 0.9.

By means of stoichiometry, the potential for reducing the platinum surface area can be reduced, and a large amount of liquid can be produced. This allows for quick conditioning and a rapid washing out of the impurities that are dissolved, for example, by the reduction in the fuel cell.

Furthermore, it is conceivable that hydrogen is supplied to the anode side with a stoichiometry relative to hydrogen greater than 1, preferably greater than 1.5, further preferably greater than 2.

This ensures that sufficient liquid, i.e., water, is produced during the reduction on the platinum surface. At the same time, it reduces the oxygen ratio in the entire fuel cell.

In the context of the invention, it may be advantageous that the drawn load current of the fuel cell drawn with a substoichiometric gas in the cathode is 20% to 50% higher than the drawn load current of the fuel cell drawn with a stoichiometric gas in the cathode.

This optimizes the conditioning of the fuel cell as the reduction must be performed with a low oxygen content. Since a higher load current is drawn than the load current specified by a customer or standard, the fuel cell may be conditioned faster to the required load current. At the same time, doing this increases the service life of the fuel cell as it is conditioned to a higher value.

In the context of the invention, it is contemplated that a load current of 0.1 A/cm² to 3A/cm² , preferably from 0.2 A/cm² to 2.5A/cm² , further preferably from 0.5 A/cm² to 2 A/cm² is drawn from the fuel cell.

This drawn load current corresponds to the specified maximum current target value. If this load current is drawn, complete and rapid conditioning of the fuel cell is performed.

When operating the fuel cell with a substoichiometric gas, the cell voltage is significantly lower than when operating with a stoichiometric gas. The cell voltage is in a voltage range from −0.1 V to +0.6 V, preferably from −0.05 V to +0.3 V.

A second aspect of the invention is a conditioning device for conditioning at least one fuel cell using a method described above, with the voltage source for applying a load voltage to the at least one fuel cell, with the gas source for supplying the substoichiometric gas via a gas supply line to the cathode side of the fuel cell, with the hydrogen source for supplying the hydrogen via a hydrogen supply line to the anode side of the fuel cell, with a control unit for controlling and/or regulating the gas source and the hydrogen source as well as for specifying the maximum current target value, wherein for conditioning, the at least one fuel cell is connectable to the voltage source and the control unit, the cathode side of the fuel cell is connectable to the gas source and the anode side of the fuel cell is connectable to the hydrogen source.

The conditioning device may be provided directly after assembly of the fuel cell and comprise a rack. It is also contemplated that the interfaces provided for connecting the fuel cell in a fuel cell system are used for connecting the gas source and the hydrogen source.

The composition of the gas in the gas source is variable, for example an air source and an additional nitrogen source may be provided in order to adjust the desired stoichiometry. With this, both the result and the duration of conditioning can be variably adjusted.

It may be contemplated in the context of the invention that the control unit is configured to access the data of the pressure sensors and voltage sensors provided in the fuel cell via an interface at the at least one fuel cell.

As a result, the pressure drop required to discharge the liquid from the channels of the cathode of the fuel cell can be determined more accurately.

At the same time, it saves the set-up time of the fuel cell to be conditioned for the conditioning method, since no further pressure and/or voltage sensors need to be installed in the fuel cell or its connections. This additionally saves costs.

Advantages that have been described in detail in the method for conditioning at least one fuel cell to a maximum current target value for operating the fuel cell, in particular a fuel cell stack, in a conditioning device according to the first aspect of the invention apply equally to the conditioning device for conditioning at least one fuel cell according to the second aspect of the invention.

Further advantages, features, and details of the invention follow from the description hereinafter, in which multiple exemplary embodiments of the invention are described in detail with reference to the drawings. In this context, the features mentioned in the claims and in the description can each be essential to the invention individually or in any combination.

### BRIEF DESCRIPTION OF THE DRAWINGS

The invention is illustrated in the following drawings:

FIG. 1 a schematic method for conditioning a fuel cell,

FIG. 2 a schematic illustration of a conditioning device.

### DETAILED DESCRIPTION

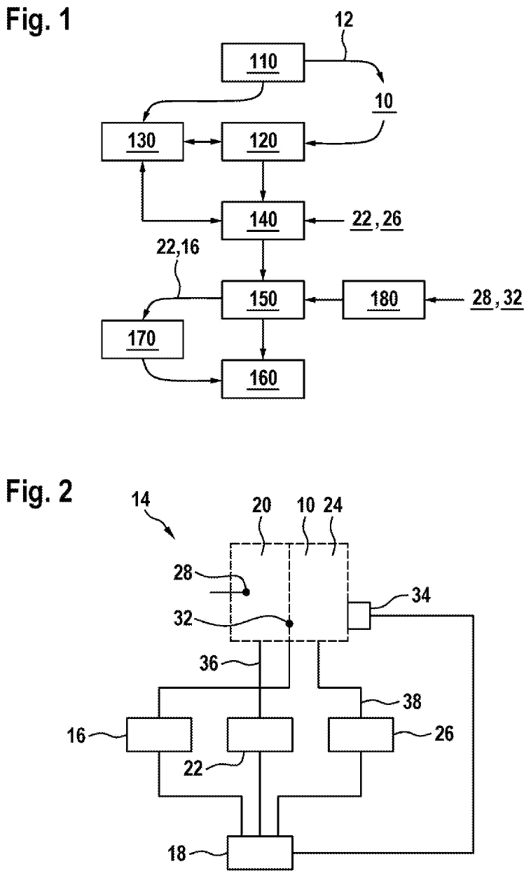

In FIG. 1, a method 100 for conditioning 160 at least one fuel cell 10 to a maximum current target value I_target for operating the fuel cell 10, in particular a fuel cell stack 12, in a conditioning device 14 is shown. The method 100 has the following steps:
applying 110 a load voltage U_load to the fuel cell 10 by means of a voltage source 16, such that a load current I_load is continuously drawn 120,
specifying 130 the maximum current target value I_target in a control unit 18,
supplying 140 a substoichiometric gas with a stoichiometry of less than 0.9 relative to oxygen to a cathode side 20 of the fuel cell 10 by means of a gas source 22, and supplying 140 hydrogen with a stoichiometry of 2 relative to hydrogen to an anode side 24 of the fuel cell 10 by means of a hydrogen source 26 for a specified duration T, wherein, during the duration T, the drawn 120 load current I_load corresponds to the maximum current target value I_target, and wherein the gas source 22 and the hydrogen source 26 are controlled and/or regulated 150 over the duration T by means of the control unit 18, whereby the fuel cell 10 is conditioned 160 to the maximum current target value I_target.

In the cathode side 20 of the fuel cell 10, a pressure drop pv is sensed 180 by means of at least one pressure sensor 28 of a sensing unit 30 and, in the fuel cell 10, a cell voltage is sensed 180 by means of at least one voltage sensor 32 of the sensing unit 30. The control unit 18 controls and/or regulates both the gas source 22 and the voltage source 16 as a function of the sensed pressure drop pv in the cathode side 20 and the sensed cell voltage in the fuel cell 10 such that
the voltage source 16 provides 170 at least one load pulse for increasing the cell voltage in the fuel cell 10, and/or
the gas source 22 provides 170 at least one gas pulse for increasing the pressure drop pv in the cathode side 20 by means of the control unit 18.

The gas pulse of the gas source 22 and the load pulse of the voltage source 16 are performed cyclically by means of the control unit 18. First, a load pulse for a pulse duration of 10s and, after a pause of 20s, a gas pulse of 10s is provided, to then be repeated cyclically. The order as well as the pulse duration can also vary.

Generally, during method 100, care is taken that the pressure drop pv in the cathode side 20 is increased by 10 mbar to 60 mbar, preferably 25 mbar to 50 mbar, further preferably 30 mbar to 45 mbar, by means of the gas pulse in the cathode side 20 and/or the load pulse in the fuel cell 10. This ensures that the channels of the cathode side 20 are free of liquid and a reduction at the platinum surface is even possible.

Depending on the type of gas and the load current I_Load to be achieved, a substoichiometric gas with a temperature of 20° C. to 100° C., preferably from 50° C. to 90° C., further preferably from 70° C. to 85° C., can be supplied to the cathode side 20. The mass flow of the gas can be regulated thereby.

To ensure that the required pressure drop pv is set, a substoichiometric gas at a pressure of 1 bar to 4 bar is supplied to the cathode side 20.

At the same time, the supplied substoichiometric gas has a relative humidity rF of between 50% and 200%. The relative humidity rF may be constant or vary throughout the conditioning process.

A drawn 120 load current I load of the fuel cell 10 drawn 120 with a substoichiometric gas in the cathode side 20 is 20% to 50% higher than the drawn 120 load current I load of the fuel cell 10 drawn 120 with a stoichiometric gas in the cathode.

This corresponds to a drawn 120 load current I_Load from 0.1 A/cm² to 3A/cm².

If the method 100 according to FIG. 1 is performed with a gas pulse of nitrogen, then after reaching a target state of the air with a temperature T=80° C., a pressure p=1 bar and a relative humidity rF=100% a maximum current target value I_target can be set above an expected current value at a stoichiometric air quantity. As a result, the cell voltage drops to ~0 V and the current oscillates around the expected value at stoichiometry of 1. At this operating point, the pressure drop pv may be low and as a result, liquid build-up may occur in the channels of the gas flow field. This is particularly relevant if the gas is pure oxygen.

In this embodiment, nitrogen is additionally mixed with the gas during the substoichiometric operation to wash out the impurity. The total flow rate in an air operation/oxygen operation is sufficient to generate a pressure drop pv greater than 25 mbar, preferably greater than 50 mbar.

To discharge the liquid from the channels of the cathode side 20, pure nitrogen is supplied to the gas as a gas pulse over a pulse duration of 1s to 20s. This briefly increases the pressure drop pv and thus pushes the liquid out of the channels or prevents the liquid from entering the channels from the outset.

Instead of nitrogen, the gas pulse may also consist of air. In the method 100 for conditioning 160, during the substoichiometric operation of the fuel cell 10, the air or oxygen supplied for operation of the fuel cell 10 is additionally mixed with air in pulses. The pulse duration of the air is 1s to 20s.

Regardless of whether nitrogen or air is supplied as a gas pulse to the fuel cell 10, the mass flow is selected or adjusted during the method 100 such that the cell voltage of the fuel cell 10 during conditioning 160 rises to a maximum of either the idle voltage of the fuel cell 10 or to a voltage of 0.75 V. This increases the pressure drop pv and the potential is increased.

The flow rate of gas for the gas pulse during air operation of the fuel cell 10 is between 0.01 times and 10 times the air flow rate for operation of the fuel cell 10. If the fuel cell 10 is operating on oxygen, the flow rate of the gas for the gas pulse may be between 0.01 times and 100 times the oxygen flow rate.

A load pulse may also be provided instead of a gas pulse, alternating with a gas pulse or overlapping with a gas pulse. By applying 110 a load pulse or a plurality of load pulses, i.e., applying 110 a voltage, the current decreases at least for the duration of the load pulse, whereby the stoichiometry of the gas is briefly greater than 1 and the cell voltage increases. The load pulse has a pulse duration of from 1s to 20s and the amount of the applied load is selected such that the cell voltage of the fuel cell 10 during conditioning 160 rises to a maximum of either the idle voltage of the fuel cell 10 or a voltage of 0.75 V.

In FIG. 2, a conditioning device 14 for conditioning 160 at least one fuel cell 10 with a method 100 according to FIG. 1 is shown. The conditioning device 14 directs the voltage source 16 to apply 110 a load voltage U_load to the at least one fuel cell 10,
the gas source 22 for supplying 140 the substoichiometric gas via a gas supply line 36 to the cathode side 20 of the fuel cell 10,
the hydrogen source 26 for supplying 140 the hydrogen via a hydrogen supply line 38 to the anode side 24 of the fuel cell 10,
control unit 18 for controlling and/or regulating 150 of the gas source 22 and the hydrogen source 26 as well as for specifying 130 the maximum current target value I_target. For conditioning 160, the at least one fuel cell 10 is connectable to the voltage source 16 and the control unit 18, the cathode side 20 of the fuel cell 10 is connectable to the gas source 22 and the anode side 24 of the fuel cell 10 is connectable to the hydrogen source 26.

The control unit 18 is configured to access the data of the pressure sensors 28 and voltage sensors 32 provided in the fuel cell 10 via an interface 34 on the at least one fuel cell 10.

1. A method (100) for conditioning (160) a fuel cell (10) to a maximum current target value (I_target) for operating the fuel cell (10), in a conditioning device (14), the method comprising:
applying (110) a load voltage (U_load) to the fuel cell (10) via a voltage source (16) such that a load current (I_load) is continuously drawn (120),
specifying (130) the maximum current target value (I_target) in a control unit (18), and
supplying (140) a substoichiometric gas to a cathode side (20) of the fuel cell (10) via a gas source (22), and supplying (140) hydrogen to an anode side (24) of the fuel cell (10) via a hydrogen source (26) for a specified duration (T) T, wherein, during the duration (T) T, the drawn (120) load current (I_load) corresponds to the maximum current target value (I_target), and wherein the gas source (22) and the hydrogen source (26) are controlled and/or regulated (150) over the duration (T) T via the control unit (18), whereby the fuel cell (10) is conditioned (160) to the maximum current target value (I_target).

2. The method (10) according to claim 1,
wherein
in the cathode side (20) of the fuel cell (10), a pressure drop (pv) is sensed via a pressure sensor (28) of a sensing unit (30), and/or in the fuel cell (10), a cell voltage is sensed via voltage sensor (32) of the sensing unit (30),
wherein the gas source (22) and/or the voltage source (16) are controlled and/or regulated (150) by the control unit (18) as a function of the sensed pressure drop (pv) in the cathode side (20) and/or the sensed cell voltage in the fuel cell (10), such that
a) the voltage source (16) provides (170) a load pulse for increasing the cell voltage in the fuel cell (10), and/or
b) the gas source (22) provides (170) a gas pulse for increasing the pressure drop (pv) in the cathode side (20) via the control unit (18).

3. The method (10) according to claim 2,
wherein
the gas pulse of the gas source (22) and/or the load pulse of the voltage source (16) is provided cyclically and/or overlapped and/or sequentially via the control unit (18).

4. The method (10) according to claim 2,
wherein
the pressure drop (pv) in the cathode side (20) is increased by 10 mbar to 500 mbar, preferably 25 mbar to 100 mbar, and/or further preferably 30 mbar to 60 mbar, via the gas pulse in the cathode side (20) and/or the load pulse in the fuel cell (10).

5. The method (10) according to claim 2,
wherein
the gas pulse and/or the load pulse is provided for a pulse duration of 0.01s to 200s, preferably 0.5s to 100s, further preferably 1s to 20s.

6. The method (10) according to claim 1,
wherein
a substoichiometric gas is supplied to the cathode side (20) at a temperature of 20° C. to 100° C., preferably from 30° C. to 80° C., further preferably from 40° C. to 70° C.

7. The method (10) according to claim 1,
wherein
a substoichiometric gas is supplied to the cathode side (20) at an absolute pressure of from 1 bar to 4 bar, preferably from 1.1 bar to 3 bar, further preferably from 1.5 bar to 2.5 bar.

8. The method (10) according to claim 1,
wherein
a substoichiometric gas is supplied to the cathode side (20) at a relative humidity of 50% to 200%, preferably 90% to 150%, further preferably 90% to 130%.

9. The method (10) according to claim 1,
wherein
a substoichiometric gas is supplied to the cathode side (20) with a stoichiometry relative to oxygen of less than 1, preferably less than 0.95, further preferably less than 0.9.

10. The method (10) according to claim 1,
wherein
hydrogen is supplied to the anode side (24) with a stoichiometry relative to hydrogen of greater than 1, preferably greater than 1.5, further preferably greater than 2.

11. The method (10) according to claim 1,
wherein
the drawn (120) load current (I_load) of the fuel cell (10) drawn (120) with a substoichiometric gas in the cathode is 20% to 50% higher than the drawn (120) load current (I_load) of the fuel cell (10) drawn (120) with a stoichiometric gas in the cathode.

12. The method (10) according to claim 1,
wherein
a load current (I_load) of 0.1 A/cm² to 3A/cm², preferably from 0.2 A/cm² to 2.5A/cm², further preferably from 0.5 A/cm² to 2 A/cm² is drawn (120) from the fuel cell (10).

13. A conditioning device (14) for conditioning (160) a fuel cell (10), the conditioning device (14) configured to
apply (110) a load voltage (U load) to the fuel cell (10) via a voltage source (16) such that a load current (I load) is continuously drawn (120),
specify (130) a maximum current target value (I target) in a control unit (18), and
supply (140) a substoichiometric gas to a cathode side (20) of the fuel cell (10) via a gas source (22), and supply (140) hydrogen to an anode side (24) of the fuel cell (10) via a hydrogen source (26) for a specified duration (T) T, wherein, during a duration (T) T, the drawn (120) load current (I_load) corresponds to the maximum current target value (I_target), and wherein the gas source (22) and the hydrogen source (26) are controlled and/or regulated (150) over the duration (T) T via a control unit (18), whereby the fuel cell (10) is conditioned (160) to the maximum current target value (I_target),
the conditioning device (14) comprising:
the voltage source (16) for applying (110) a load voltage (U_load) to the fuel cell (10),
the gas source (22) for supplying (140) the substoichiometric gas via a gas supply line (36) to the cathode side (20) of the fuel cell (10),
with the hydrogen source (26) for supplying (140) the hydrogen via a hydrogen supply line (38) to the anode side (24) of the fuel cell (10), and
the control unit (18) configured to control and/or regulate (150) the gas source (22) and the hydrogen source (26) and to specify (130) the maximum current target value (I_target),
wherein, the fuel cell (10) is configured to be connected to the voltage source (16) and the control unit (18), the cathode side (20) of the fuel cell (10) is configured to be connected to the gas source (22) and the anode side (24) of the fuel cell (10) is connectable to the hydrogen source (26).

14. The conditioning device (14) according to claim 13,
wherein
the control unit (18) is configured to access data of pressure sensors (28) and voltage sensors (32) provided in the fuel cell (10) via an interface (34) on the fuel cell (10).
